(19) United States
(12) Patent Application Publication
(10) Pub. No.: US 2009/0245710 A1
(43) Pub. Date: Oct. 1, 2009

(54) Multiple surface bearing high speed differential mechanism

(76) Inventor: Steve Meyn, San Jose, CA (US)

Correspondence Address: Lauson & Tarver LLP, 880 Apollo Street, SUITE 301, El Segundo, CA, 90245, US

(21) Appl. No.: 12/057,185

(22) Filed: Mar. 27, 2008

(51) Int. Cl. F16C 33/58

(52) U.S. Cl. 384/569

(57) ABSTRACT

An improved speed differential bearing system, comprising an inner rotating member with two races and a channel, and outer rotating member with a single race wherein bearings with rolling surfaces of differentiated size are disposed between the rotating members in a manner that connects the races of the inner rotating member with smaller rotating surfaces of the bearings and the connects the race of the outer rotating member with larger rotating surfaces of the bearings. The larger rotating surface of the bearings is disposed in a channel between the two races of the inner rotating member without touching the inner rotating member as the bearing makes its rotation. In this manner, the inner rotating member and outer rotating member are able to achieve greater speed differentials while reducing operational friction and failure while allowing the bearing speed to be as little as 25% of the shaft speed.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

Bearings are known in the art. However, due to the shape of standard bearings, the bearings spin against the inner and outer races at the same speed. This results in a lower maximum speed differential between the races, and a propensity for structural failure. The present invention uses a specialized bearing with rolling surfaces of different diameters to allow the races to travel at greatly differentiated speeds thereby reducing friction, and preventing heat build up and bearing failure.

### SUMMARY

The improved bearing mechanism of the present invention relies on bearings that present two different surfaces to the inner and outer rings of the mechanism. By presenting a smaller rolling surface to one ring and a larger rolling surface to the other, the bearings allow a greater speed differential to develop between the inner and outer rings.

The bearing mechanism comprises a first inner ring with two inner races disposed on opposite sides of a channel, and a bore in the center of the ring. A series of bearings disposed evenly along the races of the inner ring are surrounded by, and also disposed evenly along, an outer ring with an outer race. The bearings are sized so that the smaller rolling surfaces make contact with the races of the inner ring, and the larger rolling surfaces make contact with the outer ring, and wherein the rings rotate about the bearings simultaneously. Each bearing further comprises a pin hole for accommodating a pin engaging a retaining ring to preserve the spacing of the bearings.

The bearings comprise a modified cylinder with two extreme ends of a smaller diameter and a central section of a larger diameter. The extreme ends present rolling surfaces to the races of the inner ring, and the center section presents a rolling surface to the race of the outer ring. The inner ring comprises two races around its circumference with a channel disposed between the races, and a central bore. The channel disposed in the inner ring is deep enough to permit the enlarged middle area of the bearing to spin without touching the sides or bottom of the inner ring channel.

The outer ring comprises a race disposed circumferentially around its interior. This race supports the enlarged rolling surface at the middle of the bearing. A retaining ring disposed laterally against the extreme ends of the bearings is anchored to the ends of the bearings with pins extending through pin holes in the bearings and through corresponding pin holes at the junction of the extreme ends of the bearings and the retaining ring.

When the bearings are disposed between the inner ring member and the outer ring member, the smaller rolling surfaces of the bearings are supported in the races of the inner ring and the larger rolling surfaces of the bearings are supported in the race of the outer ring. In this manner, the bearings are in constant contact with the races of both ring members, which allows the members to spin at greatly differentiated speeds.

The diameter of the smaller rolling surfaces of the bearing and the diameter of the larger rolling surface of the bearing is designed to correspond with the difference in diameter between the inner ring and the outer ring so that constant non-slipping contact is maintained, and all bearing surfaces make the same number of revolutions relative to the ratio of the bearings' larger and smaller rolling surfaces.

### FIGURES

FIG. 1 is a perspective view of the bearing mechanism of the present invention, with the inner ring and bearings turned relative to the outer ring to show structural detail.

FIG. 2 is a perspective view of a bearing of the present invention.

FIG. 3 is a perspective view of the inner ring of the present invention.

FIG. 4 is a perspective view of the outer ring of the present invention.

FIG. 5 is a side view of the bearings of the present invention with the retaining ring and retaining pins holding the bearings in place.

FIG. 6 is a cut-away view of an alternate embodiment of the invention, wherein the ratios of the rolling surfaces and race diameter are greatly increased.

FIG. 7 is a side view of an alternate embodiment of the invention, wherein the ratios of the rolling surfaces and race diameters are greatly increased.

FIG. 8 is a side view of another alternate embodiment of the invention, wherein the rolling surfaces of the bearings comprise flat surfaces and an angle, and the channels of the ring members form a complimentary groove for improved axial support.

### DESCRIPTION

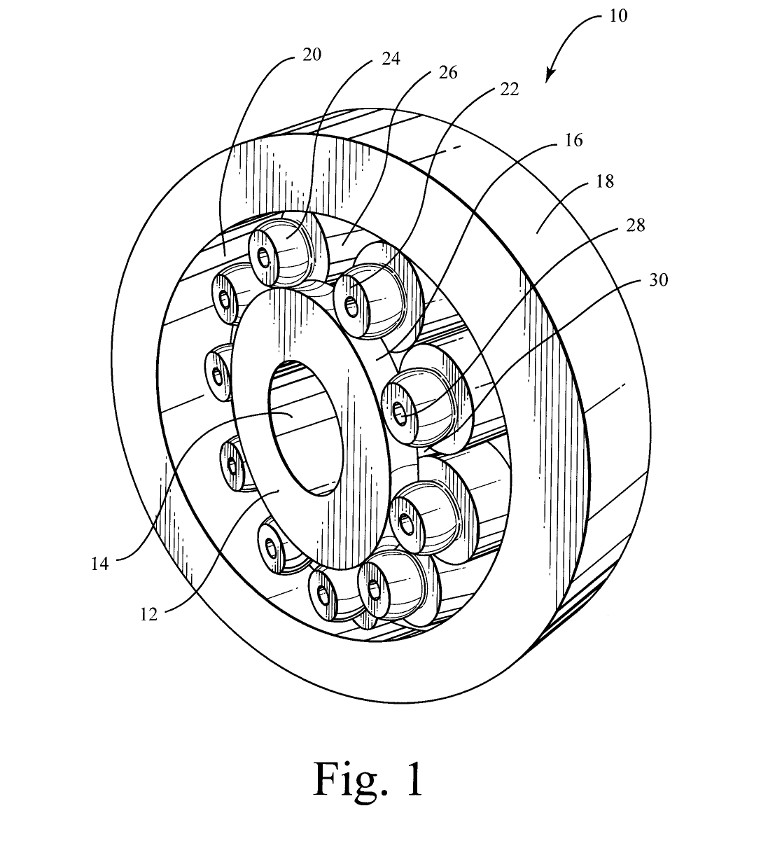

Referring to FIG. 1, an improved speed differential bearing mechanism 10 is shown with the inner ring and bearings turned slightly relative to the outer ring to show structure. The mechanism comprises a first inner ring member 12 with two (one shown) inner races 16 disposed about its circumference. The inner ring member races 16 are disposed on either side of a channel 30, and a bore 14 is disposed in the center of the inner ring member 12.

A series of bearings 22 are disposed evenly along the inner ring member races 16 and are surrounded by an outer ring member 18 with an outer ring member race 20. The bearings 22 are also disposed evenly along the outer ring member race 20, so that they roll along the inner ring member 12 and outer ring member 18 races simultaneously. Each bearing 22 further comprises a pin hole 28 for accommodating a pin that anchors a retaining means (not shown). The bearings are disposed along the races so that the smaller rolling surfaces 24 of the bearings make contact with the races 16 of the inner ring member, and the larger rolling surfaces 26 of the bearings make contact with the race 20 of the outer ring member; thereby allowing the members to rotate relative to the bearings at greatly differentiated speeds without failure.

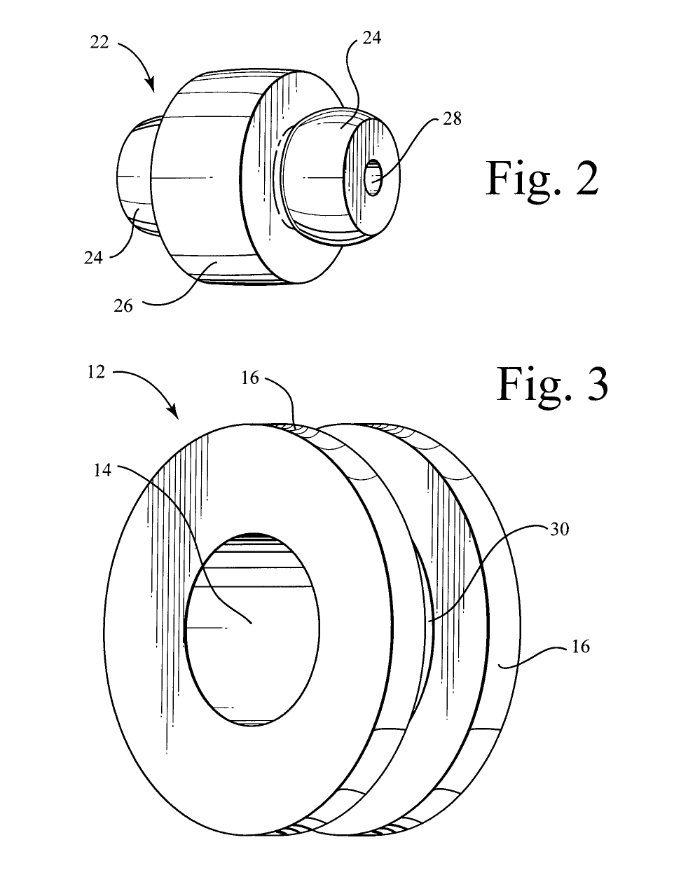

Referring to FIG. 2, a detail of a bearing 22 is shown and described. The bearing 22 comprises a modified cylinder wherein the end sections are smaller in diameter and the middle section is larger in diameter. The end sections comprise smaller rolling surfaces 24 and are of a profile that corresponds to the races of the inner ring. The middle section comprises a larger rolling surface 26 that corresponds to the race of the outer ring. A pin hole 28 is disposed through the bearing 22 for accommodating a pin about which the bearing 22 is able to spin.

Referring to FIG. 3, a detail of the inner ring member is shown. The inner ring member 12 comprises two races 16 around its circumference, a channel 30 disposed between the races, and a central bore 14 disposed through the member 12. The races 16 of the inner ring support the smaller rolling surfaces of the bearings as they travel around the member 12. The channel 30 disposed in the inner ring member 12 is deep enough to permit the enlarged middle section of the bearing and the larger rolling surface to spin therein without touching the sides or bottom of the channel 30.

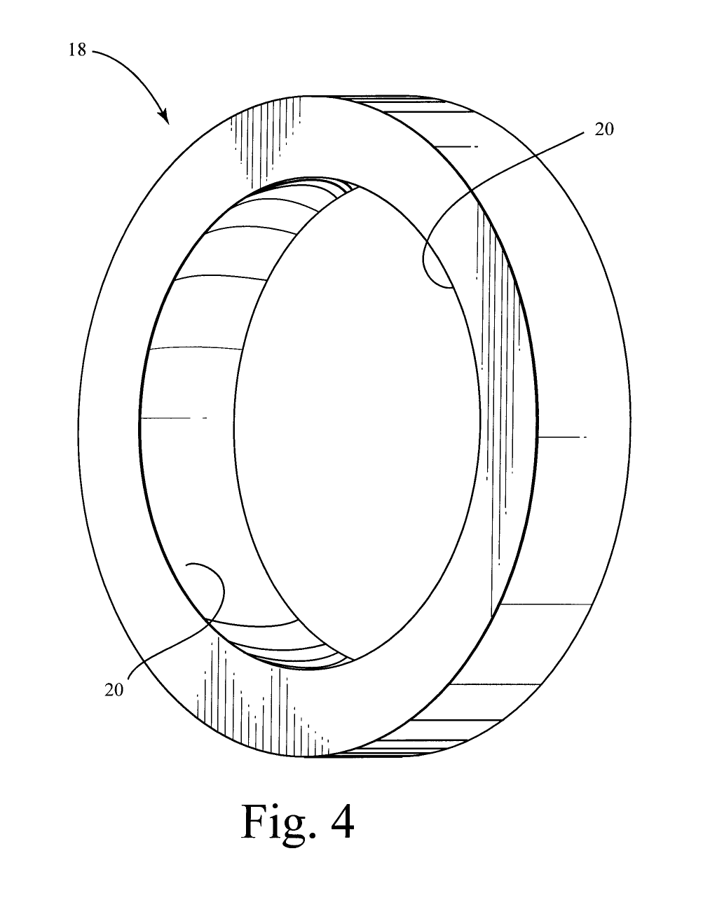

Referring to FIG. 4, a detail of the outer ring member is shown. The outer ring member 18 comprises a ring with a race 20 disposed circumferentially around its inward facing surface. The race 20 supports the outer bearing rolling surface as the bearings travel around the race.

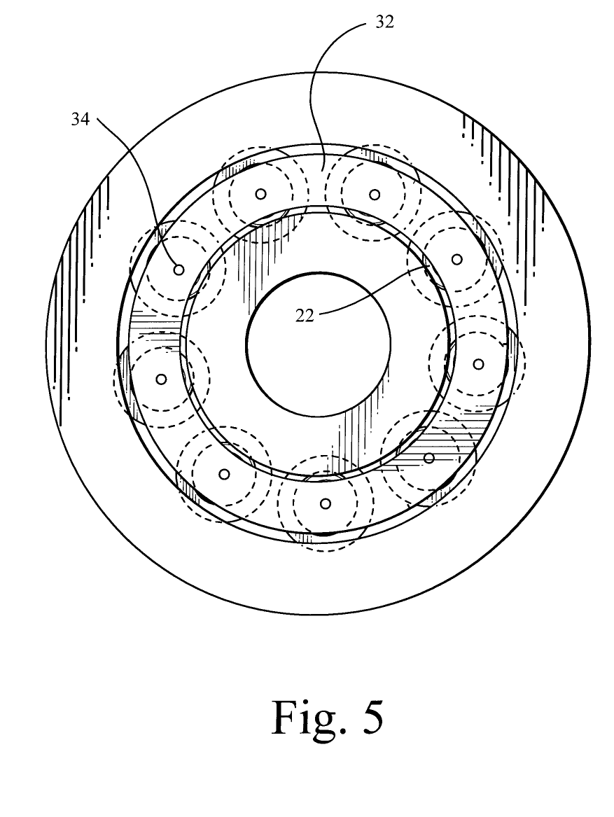

Referring to FIG. 5, the mechanism is shown with the retaining ring in place. The retaining ring 32 comprises a ring disposed laterally against the extreme ends of the bearings 22, and is anchored to the ends of the bearings with pins that extend through the pin holes in the bearings and corresponds to secondary pin holes 34 disposed at the junction of the bearings and the retaining ring.

When the bearings are disposed between the inner ring member and the outer ring member, the smaller rolling surfaces of the bearings are supported by the races of the inner ring member. Simultaneously, the enlarged middle of the bearing and larger rolling surface is supported in the race of the outer ring member. In this manner, the bearings are in constant contact with the races of both ring members. Additionally, the diameter of the bearings' smaller rolling surfaces and larger rolling surface is sized to correspond with the difference in diameter between the inner ring member and the outer ring member, so that all bearing surfaces make the same number of revolutions relative to the ring members, while allowing the ring members to travel at different speeds or the exact same speed depending on the ratio of the design.

In one preferred embodiment of the invention, the outer circumference of the inner ring member is 6.91152 inches and the inner circumference of the outer ring member is 11.0018 inches. Likewise the smaller rolling surface of the bearings is 1.5708 inches and the larger rolling surface is 2.51328 inches. Therefore the diameter ratio of the smaller rolling surface to the larger rolling surface of the bearings is 0.500/0.800 or 0.625:1 permitting the bearings to roll exactly 4.3 times around the first and second ring members simultaneously.

The races of the inner and outer ring members have complimentary profiles. This serves to preserve the bearing in the race. In one embodiment, concave surfaces on the races of the inner ring member are 0.225 inches wide and are defined by an arc with a radius of 3.02 inches; the concave surface of the outer ring member is 1.000 inches wide and defined by an arc with a radius of 1.751 inches.

In another preferred embodiment of the invention, washers (not shown) are disposed between the retaining rings and the terminal ends of the bearings. In yet another embodiment, a conventional bearing cage is used to retain the bearings.

In another preferred embodiment of the invention, the mechanism comprises ten evenly spaced bearings. However different embodiments comprising different sized mechanisms and different numbers of bearings are contemplated.

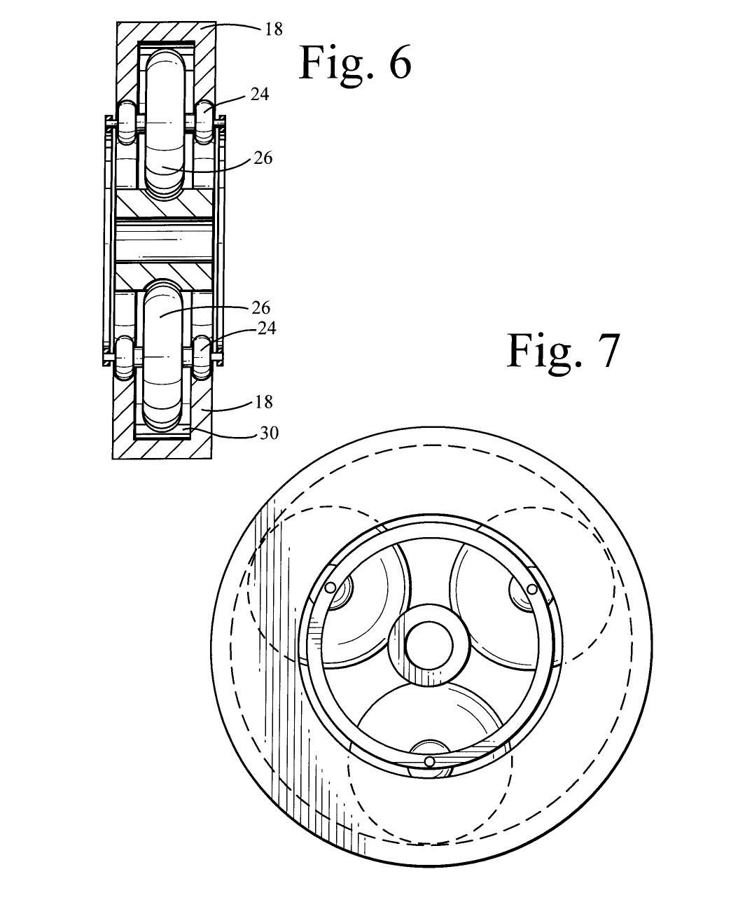

Referring to FIGS. 6 and 7, an alternative design of the mechanism is shown for use in situations where greater speed differential is necessary. In this embodiment, the bearings comprise a greatly enlarged rolling surface 26, and a greatly reduced rolling surface 24. Also in this embodiment, the channel 30 is disposed in the outer ring 18, which supports smaller rolling surfaces 24. The larger rolling surface 26 abuts the inner ring. This design allows the bearing to rotate at as little as 25% of the inner ring's rotational speed.

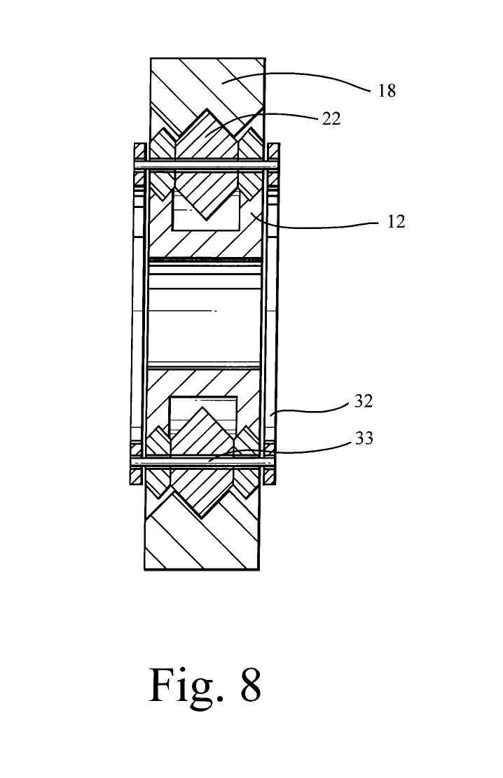

Referring to FIG. 8, another alternative design of the bearing is shown, wherein the rolling surfaces of the bearings are characterized by a V-shaped profile which corresponds to a similar profile on the races of the ring members. In this embodiment, the race of the outer ring 18 corresponds to the V-shaped rolling surface of the bearing 22, and the inner ring 12, corresponds to the remaining rolling surfaces. This embodiment also includes a retaining ring 32 and pins 33 for spacing retention.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An improved speed differential bearing mechanism comprising;
a. a first ring member comprising two races disposed along its outer circumferential surface and a channel disposed between the races;
b. a second ring member comprising a race along its inner circumferential surface;
c. at least one bearing comprising two smaller rolling surfaces for contact with the inner races, and one larger rolling surface for contact with the outer race; and
d. a retaining means for preserving the position of the at least one bearing relative to the rings, wherein the smaller rolling surfaces of the at least one bearing make contact with the races of the first ring member, and the larger rolling surface of the at least one bearing makes contact with the race of the second ring member so that the ring members rotate about the at least one bearing; and wherein the retaining means preserves the position of the at least one bearing relative to the ring members.

2. The mechanism of claim 1, wherein the at least one bearing comprises a modified cylinder, wherein the diameter of the middle of the cylinder is larger in diameter than the ends of the cylinder; and wherein the ends of the cylinder contact the races of the first ring member, and the middle of the cylinder contacts the race of the second ring member.

3. The mechanism of claim 1, wherein the first ring member comprises a central bore and wherein the smaller rolling surfaces at the ends of the at least one bearing contact the races of the first ring member, while the larger rolling surface at the middle of the at least one bearing depends into the channel between the races of the first ring member without touching the first ring member.

4. The mechanism of claim 1, wherein the second ring member comprises a central bore accommodating the first ring member and the at least one bearing in such a way that the second ring member contacts only the second rolling surface of the at least one bearing.

5. The mechanism of claim 1, wherein the rolling surfaces of the at least one bearing and races of the first ring member and second ring member have complimentary profiles.

6. The mechanism of claim 1, wherein the outer ring comprises two races and a channel, and the smaller rolling surfaces of the at least one bearing travel along the outer ring, and wherein the larger rolling surface of the at least one bearing travels in the channel of the outer ring and roll against a race on the inner ring.

7. The mechanism of claim 6, wherein the ratio of the rolling surfaces of the at least one bearing is 4:1.

8. The mechanism of claim 1, wherein the rolling surfaces of the at least one bearing come to a point formed by two straight-line sides, and travel in a corresponding V-shaped race.

9. The mechanism of claim 1, wherein the retaining means comprises a pair of rings that abut the terminal ends of the at least one bearing.

10. The mechanism of claim 9, wherein a hole is disposed through the at least one bearing from one terminal end to the other terminal end, corresponding to a hole disposed in the retaining means at the junction of the at least one bearing and the retaining means, so that a pin may be inserted through the holes to preserve the orientation of the at least one bearing relative to the retaining means.

11. The mechanism of claim 10, wherein the pins are fastened by pressed fit into the retaining ring.

12. The mechanism of claim 10, wherein washers are disposed between the retaining means and the terminal ends of the at least one bearing.

13. The mechanism of claim 1, wherein a conventional bearing cage is used to retain the at least one bearing.

14. The mechanism of claim 13, wherein the conventional bearing cage adjoins one side of the smaller rolling surface of the at least one bearing and passes through the opining between bearings.

15. The mechanism of claim 1, wherein the mechanism comprises ten evenly spaced bearings.

16. The mechanism of claim 1, wherein the diameter ratio of the first rolling surface to the second rolling surface of the at least one bearing is 0.500/0.800 or 0.625:1 permitting both surfaces of the at least one bearing to roll 4.3 times around the first and second ring members.

17. The mechanism of claim 16, wherein the differential between the inner and outer rings is confined to a distance of 0.039 of an inch or less.

18. The mechanism of claim 5, wherein the concave surfaces of the race of the first ring member are 0.225 inches wide and defined by an arc with a radius of 3.02 inches.

19. The mechanism of claim 5, wherein the concave surface of the race of the second ring member is 1.000 inches wide and defined by an arc with a radius of 1.751 inches.
